(19) United States
(12) Patent Application Publication
(10) Pub. No.: US 2003/0221300 A1
(43) Pub. Date: Dec. 4, 2003

(54) L Anthony burial urn method

(76) Inventor: Lawrence Anthony Caven, MoorPark, CA (US)

Correspondence Address: LAWRENCE ANTHONY CAVEN, 78 Wicks Rd., MoorPark, CA, 93021, US

(21) Appl. No.: 10/395,733

(22) Filed: Mar. 25, 2003

Related U.S. Application Data
(60) Provisional application No. 60/369,156, filed on Apr. 2, 2002.

(51) Int. Cl. A61G 17/00

(52) U.S. Cl. 27/1

(57) ABSTRACT

Ashes remains permanent remembrance

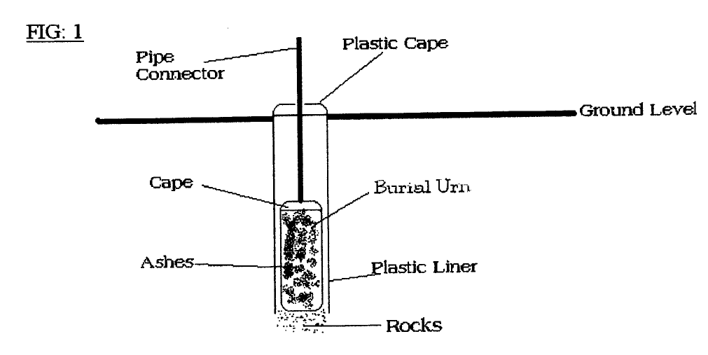

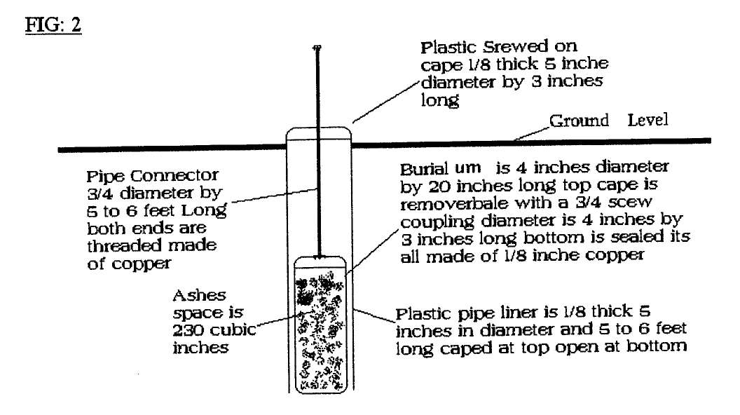

1/Burial of the pod with the Ashes of deceased person or pets inside,

The burial pod is 230 cubic Inches, 4 inches diameter by 20 inches long made of copper.

Hole drilled into the earth 5 inches diameter 5 To 6 Feet deep

A plastic Liner is installed 5 inches diameter 5 To 6 Feet long

The touching pipe is connected to the pod made of copper,

The pod urn is placed inside the plastic liner, which can be retrieved if needed,

Pod urn can be in your own garden or place of chose,

Loved ones can be placed together or next to each other,

Animals can be placed next to loved ones, As part of the family,

Dues not take much room saves on space that is very costly,

### BACKGROUND OF THE INVENTION

The L Anthony Burial urn theory was developed over years of investigation, Into the methods of burial. Through the year of burial, the methods have stayed the same.

But the mention of crossing over to the other side is all ways mentioned,

The days of the Egyptians had great believes in this,

And over faiths believe in some sort of reincarnation.

My method looks at the ones that are left, the loved ones and the grief of they're passing,

And the way we look at life these days,

It is an important step in the healing process.

Pod urns serve as a focal point for remembrance when family members visit the resting-place helping them to ease their grief and sorrow.

What I claim as my invention is the, L Anthony burial urn method

1/ L Anthony burial urn is made of a polished copper material,

2/ The burial urn is 230 cubic Inches, 4 inches diameter by 20 inches long and ⅛″ thick,

3/ The pod: casing is placed into the earth which is 5″ diameter and 5 feet deep,

4/ The pod urn is placed inside: which can be retrieved if needed,

5/ Pod urn can be in your own garden or place of choice,

6/ Loved ones can be placed together or next to each other,

7/ Animals can be placed next to loved ones, As part of the family,

8/ Will not take much room saves on space that is very costly,
